(19) United States
(12) Patent Application Publication
(10) Pub. No.: US 2014/0324921 A1
(43) Pub. Date: Oct. 30, 2014

(54) ELECTRONIC DEVICE, METHOD, AND STORAGE MEDIUM

(71) Applicant: Kabushiki Kaisha Toshiba, Tokyo (JP)

(72) Inventor: Yoshikata Tobita, Nishitokyo-shi (JP)

(73) Assignee: Kabushiki Kaisha Toshiba, Tokyo (JP)

(21) Appl. No.: 14/067,807

(22) Filed: Oct. 30, 2013

(30) Foreign Application Priority Data
Apr. 26, 2013 (JP) 2013-094509

(51) Int. Cl. G06F 17/30

(52) U.S. Cl. CPC G06F 17/30247
USPC 707/812

(57) ABSTRACT

According to one embodiment, an electronic device includes a recording module, an analysis module, a decision module, and a sending module. The recording module is configured to record a plurality of image files at logical recording locations. The analysis module is configured to analyze attributes of the plurality of image files. The decision module is configured to decide a representative image for each of the recording locations based on the attributes. The sending module is configured to send the representative image.

### CROSS-REFERENCE TO RELATED APPLICATIONS

This application is based upon and claims the benefit of priority from Japanese Patent Application No. 2013-094509, filed Apr. 26, 2013, the entire contents of which are incorporated herein by reference.

### FIELD

Embodiments described herein relate generally to an electronic device, a method, and a storage medium that classify and record files.

### BACKGROUND

When a plurality of data files is recorded by an electronic device such as a content server that delivers content like photos, moving images, and music, a personal computer or the like, data files are frequently classified hierarchically according to content of the data files by creating a logical hierarchical structure for recording. For example, the electronic device creates a plurality of folders in accordance with content of data files and further creates a plurality of sub-folders for one folder. The user records related data files in folders in each layer together.

It is possible to classify and record a plurality of data files by creating a logical hierarchical structure as above described. However, when the number of layers in the created logical hierarchical structure is large or when the number of folders contained in each of the layers is large, it is difficult to easily identify a required file.

For example, when image files such as photos or the like are recorded to the content server having a plurality of folders, the user identifies a folder including a desired photo based on names of a plurality of folders in order to browse the photo related to a certain event such as a trip or the like by using a client terminal. However, if the folder is not identified based on names of a plurality of folders or the like, the user must open a plurality of folders in turn and identifying photos recorded in each of the plurality of folders in order to find a desired folder. In this case, the user spends much time and labor.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing a configuration of a content delivery system according to a first embodiment;

FIG. 2 is an exemplary block diagram showing a function configuration of a content server according to the first embodiment;

FIG. 3 is an exemplary diagram showing a system configuration of an electronic device according to the first embodiment;

FIG. 4 is an exemplary block diagram showing the function configuration of the content delivery system realized by the content server and the electronic device in the first embodiment;

FIG. 5 is an exemplary flow chart showing an operation of a content analysis module according to the first embodiment;

FIG. 6 is a diagram showing an example of analysis information recorded in a content data table according to the first embodiment;

FIG. 7 is a diagram showing an example of the content data table in the first embodiment;

FIG. 8 is a diagram showing an example of an object data table in the first embodiment;

FIG. 9 is a diagram showing an example of an object group data table in the first embodiment;

FIG. 10 is a diagram showing an example of a logical hierarchical structure constructed in a content storage module in the first embodiment;

FIG. 11 is an exemplary flow chart showing the operation of a file manager of the electronic device in the first embodiment;

FIG. 12 is a diagram showing an example in which a representative image is added to an icon of a folder in the first embodiment;

FIG. 13 is a diagram showing an example of a folder browsing screen in the first embodiment;

FIG. 14 is a diagram showing an example of the folder browsing screen in the first embodiment; and

FIG. 15 is an exemplary block diagram showing the function configuration of an electronic device according to a second embodiment.

### DETAILED DESCRIPTION

Various embodiments will be described hereinafter with reference to the accompanying drawings.

In general, according to one embodiment, an electronic device includes a recording module, an analysis module, a decision module, and a sending module. The recording module is configured to record a plurality of image files at logical recording locations. The analysis module is configured to analyze attributes of the plurality of image files. The decision module is configured to decide a representative image for each of the recording locations based on the attributes. The sending module is configured to send the representative image.

### First Embodiment

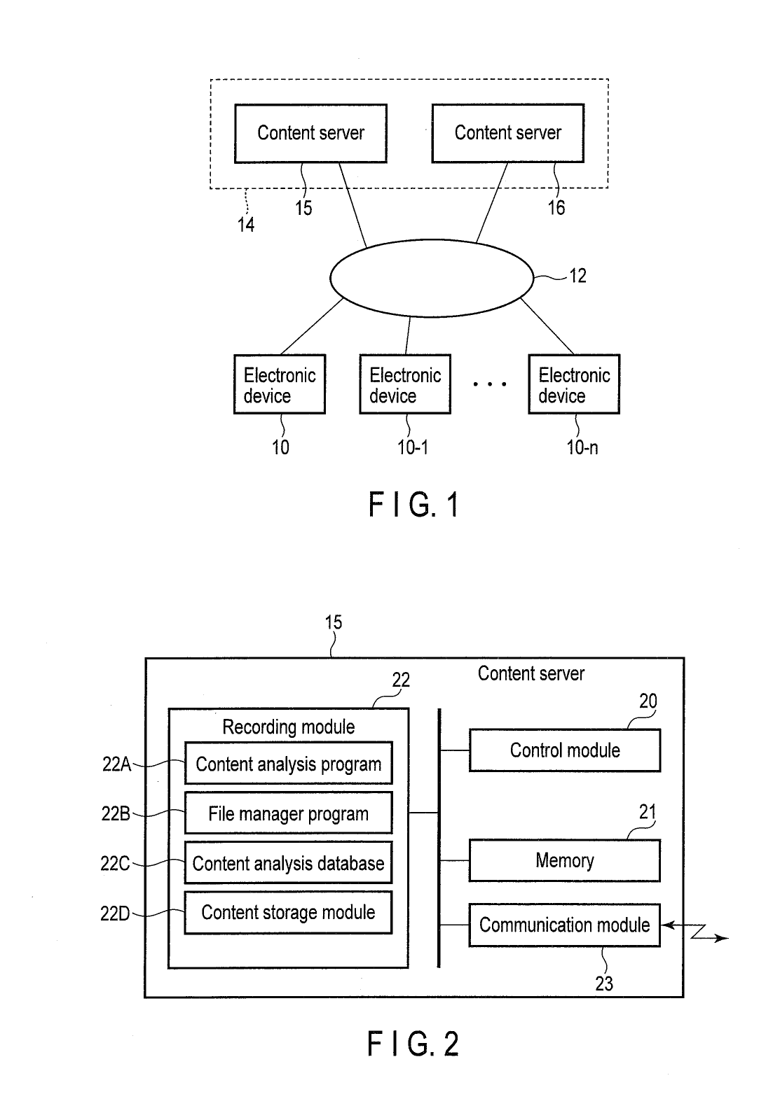

FIG. 1 is a block diagram showing the configuration of a content delivery system according to the first embodiment. In the content delivery system shown in FIG. 1, a plurality of electronic devices 10, 10-1, . . . , 10-n used by users is connected to content servers 15, 16 via a network 12. As the network, various kinds of networks such as a LAN (Local Area Network), the Internet, and a public telephone network can be used. The network is not limited to wire communication and wireless communication may also be adopted.

The content servers 15, 16 have a function to deliver data files of content such as still images (photos), dynamic images, and music through the network 12. The content servers 15, 16 record data files transmitted from the electronic devices 10, 10-1, . . . , 10-n by user and provides a service (storage service) that can optionally be browsed through the network 12. The content servers 15, 16 may operate independently or cooperate to function as a cloud service system 14.

The content servers 15, 16 store many pieces of content (data files) in a content storage module in which a logical hierarchical structure is constructed. In the logical hierarchical structure, a plurality of folders is created in each layer and data files are classified and recorded in each folder.

As the electronic devices 10, 10-1, . . . , 10-n, for example, mobile electronic devices may be used. Mobile electronic devices include, for example, personal computers, tablet PCs, mobile phones, smartphones, and audio players. The electronic devices 10, 10-1, . . . , 10-n can access the content servers 15, 16 to upload data files of still images like photos created by the user, dynamic images, music and the like.

FIG. 2 is a block diagram showing a function configuration of the content server 15 according to the first embodiment. The content server 16 is assumed to be configured in the same manner as the content server 15 and a detailed description is omitted.

The content server 15 is realized by, for example, a computer and includes a control module 20, a memory 21, a recording module 22, and a communication module 23.

The control module 20 includes a controller configured by a system LSI or the like and the controller includes a processor (CPU) and various units for image processing. The control module 20 controls various kinds of processing by executing programs recorded in the recording module 22. For example, the control module 20 controls processing to receive various kinds of content (data files) from the electronic devices 10, 10-1, . . . , 10-n and to record the content in the recording module 22 and processing to provide data files in response to access requests to content (data files) from the electronic devices 10, 10-1, . . . , 10-n. The control module 20 also analyzes attributes representing features of content (data files including image files) recorded in the recording module 22 (content storage module 22D) by executing a content analysis program 22A. The control module 20 also transmits the name and a representative image of an object (a folder or the like) representing a logical recording location (for example, a folder where content is classified and recorded) specified to be browsed in response to content browsing requests from the electronic devices 10, 10-1, . . . , 10-n (file viewers) by executing a file manager program 22B.

The memory 21 temporarily records various programs executed by the control module 20 and data accompanying execution of various programs.

The recording module 22 is realized by an apparatus having an HDD, SSD, or optical disk as a recording medium and records various programs and data. Programs recorded in the recording module 22 include, in addition to the basic program (OS), the content analysis program 22A and the file manager program 22B. The recording module 22 is also provided with the content storage module 22D which records data files of various kinds of content and a content analysis database 22C which records data for content analysis processing to be executed based on the content analysis program 22A.

In the content storage module 22D, folders are created in a plurality of layers as logical recording locations and a plurality of data files of content is classified and recorded in the folders of each layer. Content includes still images, dynamic images, and music.

The communication module 23 includes a controller that controls communication with other electronic devices (such as the content servers 15, 16). The communication module 23 transmits/receives data to/from other electronic devices through the network 12.

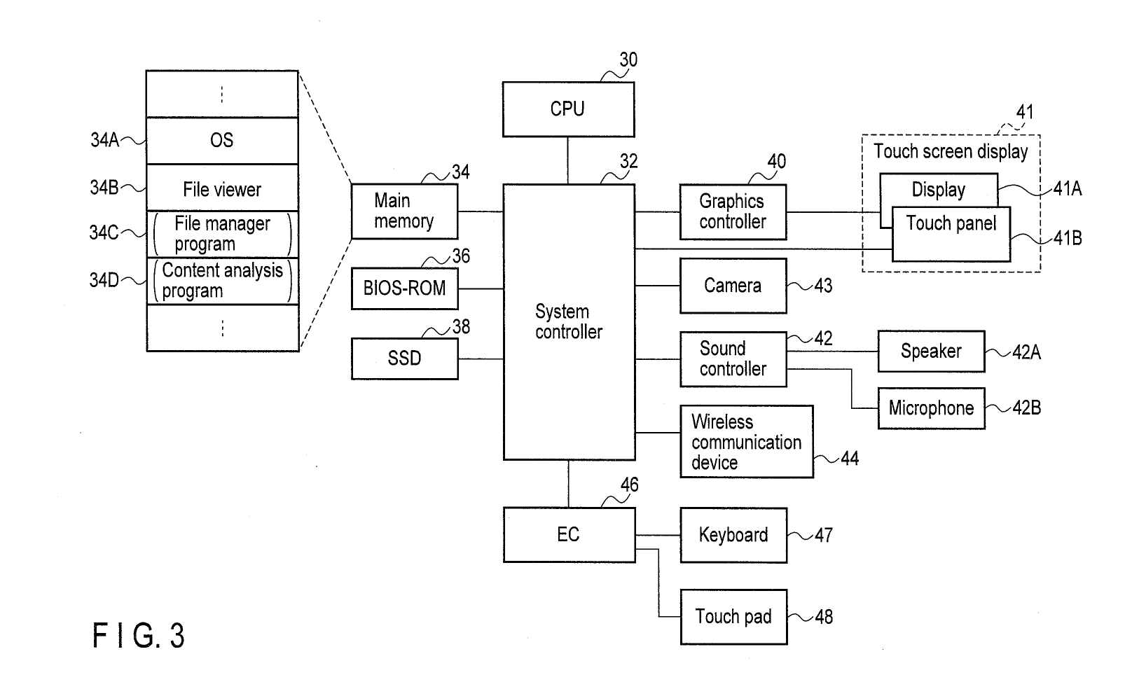

FIG. 3 is a diagram showing the system configuration of the electronic device 10 according to the first embodiment. The electronic device 10 shown in FIG. 3 shows an example of the personal computer.

The electronic device 10 includes, as shown in FIG. 3, a CPU 30, a system controller 32, a main memory 34, a BIOS-ROM 36, an SSD (Solid State Drive) 38, a graphic controller 40, a sound controller 42, a wireless communication device 44, and an embedded controller (EC) 46.

The CPU 30 is a processor that controls operations of various modules in the electronic device 10. The CPU 30 executes various programs loaded into the main memory 34 from the SSD 38 as a nonvolatile storage device. Programs include an operating system (OS) 34A and a file viewer 34B. A content analysis program 34C and a file manager program 34D will be described in the second embodiment.

The CPU 30 also executes a basic input/output system (BIOS) stored in the BIOS-ROM 36. The BIOS is a program to control hardware.

The system controller 32 is a device connecting the CPU 30 and various components. In addition to a camera 43 and the main memory 34, the BIOS-ROM 36, the SSD 38, the graphic controller 40, the sound controller 42, the wireless communication device 44, and the embedded controller (EC) 46 are connected to the system controller 32.

The graphic controller 40 controls a display 41A used as a display monitor of the electronic device 10. The graphic controller 40 transmits a display signal to the display 41A under the control of the CPU 30. The display 41A displays a screen image based on the display signal. A touch panel 41B is arranged on the display surface of the display 41A.

The sound controller 42 is a controller that processes a sound signal and controls sound output by a speaker 42A and sound input from a microphone 42B.

The wireless communication device 44 is a device configured to perform wireless communication such as wireless LAN, 3G mobile communication or the like or wireless proximity communication such as NFC (Near Field Communication).

The embedded controller 46 is a one-chip microcomputer including a controller for power management. The embedded controller 46 has a function to turn on or turn off the electronic device 10 in accordance with an operation of the power button by the user. The embedded controller 46 also controls input of a keyboard 47 and a touch pad 48.

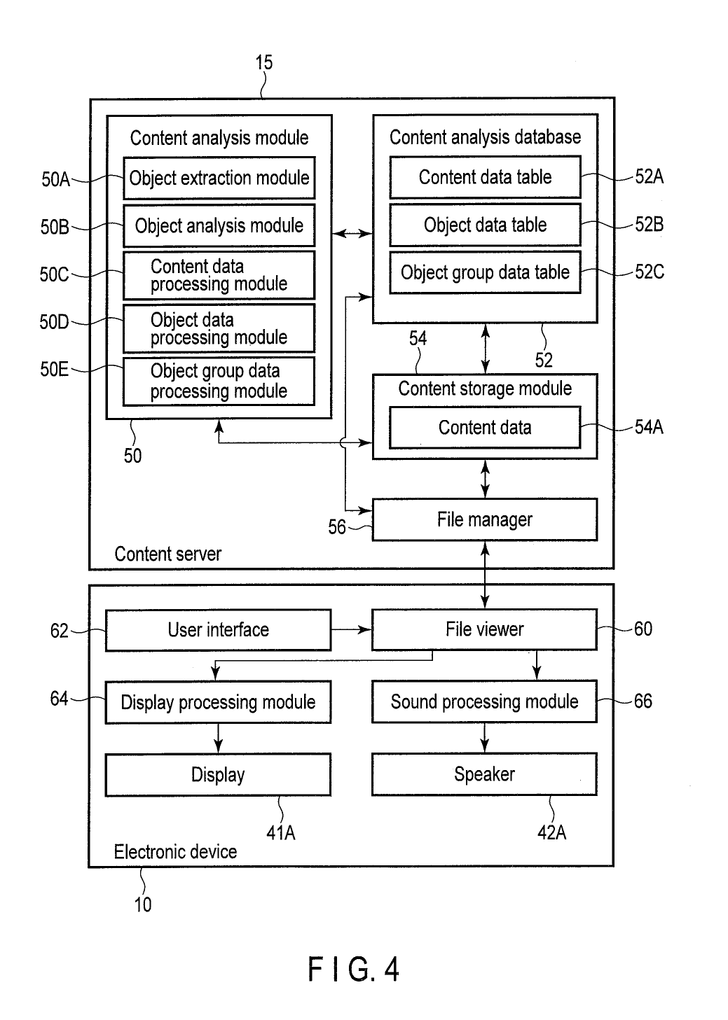

FIG. 4 is a block diagram showing the function configuration of the content delivery system realized by the content server 15 and the electronic device 10.

The content server 15 includes, as shown in FIG. 4, a content analysis module 50, a content analysis database 52 (corresponding to the content analysis database 22C in FIG. 2), a content storage module 54 (corresponding to the content storage module 22D in FIG. 2), and a file manager 56. The content analysis module 50 is realized by the content analysis program 22A being executed by the control module 20. The file manager 56 is realized by the file manager program 22B being executed by the control module 20.

The content analysis module 50 includes an object extraction module 50A, an object analysis module 50B, a content data processing module 50C, an object data processing module 50D, and an object group data processing module 50E.

The content analysis module 50 decides the representative image representing a plurality of data files in a folder in a logical hierarchical structure constituted in the content storage module 54 based on attributes of content recorded in the content storage module 54. The representative image decided for each folder is added to the respective folder and displayed when the folder is displayed in a file viewer 60 of the electronic device 10.

In the present embodiment, the content analysis module 50 extracts a representative object from image files recorded in the content storage module 54 and decides content (image file) containing the representative object or an image showing the representative object as a representative image. The content analysis module 50 extracts, based on attributes of a plurality of image files, specific objects contained in the image files and decides the representative object showing features of images from a plurality of objects. Objects extracted from image files include persons, natural objects (mountains, rivers, the sea and the like) contained in a landscape, structures (buildings and the like), animals and plants, food, vehicles and the like.

Attributes of image files include, for example, analysis information obtained by analyzing images and information set in connection with image files.

Analysis information obtained by analyzing images includes, when the object is a person, the degree of smiling face, definition, degree of frontality, number of persons, capturing location (generation location) and capturing time of an image and the like. Information set in connection with image files includes names of persons, natural objects, structures, animals and plants, food, vehicles and the like and information acquired from various kinds of data related to image files.

The object extraction module 50A extracts specific objects determined in advance from image files contained in content data 54A (data files) recorded in the content storage module 54. The object extraction module 50A may extract applicable objects from images represented by image files by presetting, for example, persons, natural objects, structures, animals and plants, food, vehicles or the like described above or extract objects specified by the user in advance. When the user sets, for example, objects of persons as targets to be extracted, the object extraction module 50A retrieves partial images corresponding to persons from images and extracts such partial images. Partial images corresponding to persons can be retrieved for by setting, for example, a face image, a whole body, or a portion of the body (upper half of the body or the like) as the target.

The object analysis module 50B decides the representative object from objects extracted by the object extraction module 50A based on attributes of a plurality of image files and decides the representative image based on the representative object. For example, the object analysis module 50B calculates the object priority (first priority) for each of a plurality of objects contained in a plurality of image files based on attributes (for example, the degree of smiling face, definition, degree of frontality and the like of face images of persons). The object analysis module 50B also discriminates the state of appearance of each of a plurality of objects and calculates the object group priority (second priority) of the plurality of objects based on the state of appearance. The state of appearance is determined by using, for example, the total of the number of pieces or reproduction time of content including each object of the same object group or the total of the time or area appearing in content of each object contained in the same object group.

The object analysis module 50B calculates the content priority based on the object priority (first priority) and the object group priority (second priority) and extracts the representative image from content (image files) of a high content priority based on the content priority. The representative image may be extracted from content (file images) of the highest content priority or a plurality of representative images may be extracted from a plurality of pieces of content (image files) in descending order of content priority.

The content data processing module 50C manages a content data table 52A recorded in the content analysis database 52 in accordance with processing by the object extraction module 50A and the object analysis module 50B.

The object data processing module 50D manages an object data table 52B recorded in the content analysis database 52 in accordance with processing by the object extraction module 50A and the object analysis module 50B.

The object group data processing module 50E manages an object group data table 52C recorded in the content analysis database 52 in accordance with processing by the object extraction module 50A and the object analysis module 50B.

In the content data table 52A, the analysis information (attributes) of objects extracted from content, content path showing the storage location of the content, and data indicating the content priority calculated by the object analysis module 50B are recorded by associating with the content ID (identification information) set to each piece of the content (image files).

In the object data table 52B, the content ID indicating content from which an object is detected, object group ID (identification information) set to each object corresponding to the same entity, and object priority (first priority) decided by the object analysis module 50B based on attributes (analysis information) of content (or objects) are recorded by associating with the object group ID (identification information) set to each object extracted from the content (image files). When, for example, objects (for example, face images) corresponding to the same person are extracted from a plurality of pieces of content (images), a common object group ID common to the objects corresponding to the same person is set.

In the object group data table 52C, the object group data priority (second priority) decided by the object analysis module 50B based on the state of appearance of objects contained in an object group and associating with the object group ID is set.

The file manager 56 provides a file recorded in the content storage module 54 in response to an access request from the file viewer 60 of the electronic device 10 or records a file transmitted through the file viewer 60 in the content storage module 54. In addition, the file manager 56 receives an instruction for creating a sub-folder and specifying the sub-folder name and the like from the user through the file viewer 60, to create the sub-folder. The file manager 56 transmits, in response to the specification of a browsing folder from the file viewer 60, content (data files) immediately below the browsing folder, names of sub-folders created in the browsing folder, and representative images of the browsing folder to the file viewer 60. The file manager 56 decides representative images of sub-folders based on the content priority recorded in the content data table 52A. Incidentally, the file manager 56 may transmit one representative image for one folder or a plurality of representative images in descending order of content priority.

The electronic device 10 includes the file viewer 60, a user interface 62, a display processing module 64, a sound processing module 66, the display 41A, and the speaker 42A.

The file viewer 60 transmits a browsing request of a file or folder to the file manager 56 of the content server 15 in accordance with instructions from the user input through the user interface 62. The file viewer 60 causes the display 41A to display images through the display processing module 64 based on an image file (still images, dynamic images) received from the file manager 56. The file viewer 60 also causes the speaker 42A to output sound through the sound processing module 66 based on a music file received from the file manager 56.

Next, the operation in the first embodiment will be described.

In the first embodiment, the representative image for each of a plurality of folders set to the content storage module 54 on the content server 15 is decided based on data files recorded in the respective folder and is released to the electronic device 10 requesting to browse content.

When a storage service provided by the content server 15 is used, the user of the electronic device 10 can define a storage location having a hierarchical structure in a storage area for users of the content storage module 54. That is, the storage location can be made hierarchical by creating a folder representing a storage location of data files and by further creating a sub-folder in the folder. Similarly, the hierarchical number can be increased by further creating a folder in the sub-folder. In a folder of a certain layer, in addition to any number of folders indicating lower-layer storage locations, any data file can be recorded.

The user of the electronic device 10 can record an image file of images captured by, for example, a digital camera by specifying a specific folder defined in the content storage module 54.

The content storage module 54 may contain not only data files uploaded by the user, but also content (data files) created in advance by the administrator of the content server 15.

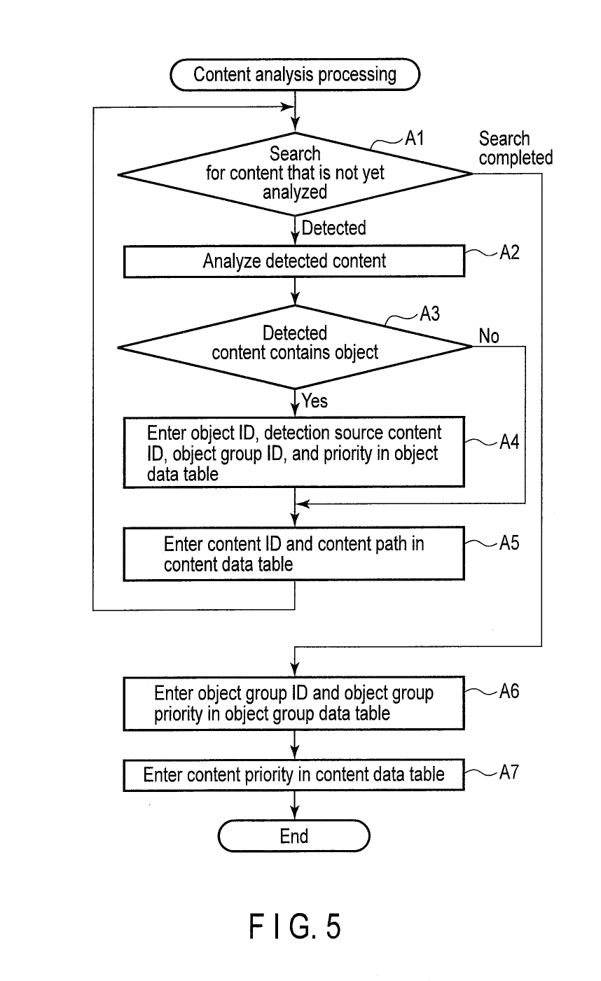

FIG. 5 is a flow chart showing the operation of the content analysis module 50 according to the first embodiment.

The content analysis module 50 searches content which is not yet analyzed from contents recorded in the content storage module 54. The content analysis module 50 may make a search in timing determined in advance or in timing specified by the user or make a search in timing when new content is recorded.

When content that is not yet analyzed is detected from the content storage module 54 (step A1), the content analysis module 50 analyzes the detected content not yet analyzed (step A2). Here, the content analysis module 50 extracts specific objects contained in an image file and decided in advance through the object extraction module 50A and acquires analysis information representing features of each object through the object analysis module 50B.

For example, the object extraction module 50A has a face recognition function to recognize a face image region of a person from inside an image. By the face recognition function, for example, the object extraction module 50A can search for face image regions having features similar to those of a face image feature sample prepared in advance. The face image feature sample is feature data obtained by statistically processing face image features of each of many persons. The position (coordinates) and size of face image regions contained in an image are recorded by the face recognition function.

Further, the object analysis module 50B analyzes image features of face image regions by the face recognition function. The object analysis module 50B calculates, for example, the degree of smiling face, definition, and degree of frontality of a detected face image. The degree of smiling face is an index showing the degree to which the detected face image is a smiling face. The definition is an index showing the degree to which the detected face image is sharp. The degree of frontality is an index showing the degree to which the detected face image is oriented toward the front. The object analysis module 50B classifies a face image into images of each person, attaches identification information (personal ID) for each person, and records respective indexes as object attributes.

In addition, the object extraction module 50A has, for example, a landscape recognition function to recognize a landscape (images other than persons) from inside an image. Like the above face recognition function, the landscape recognition function can recognize the type of a landscape and objects (natural objects, structures and the like) contained in the landscape by analyzing features similar to feature samples of landscape images. In addition, features of landscape images can be recognized from the color tone, composition and the like of images. The object analysis module 50B records indexes showing image features recognized by the landscape recognition function as object attributes.

The object analysis module 50B can also analyze image attributes based on information attached to images. For example, the object analysis module 50B recognizes the generation date/time (capturing date/time) and generation location of an image. Further, the object analysis module 50B classifies an image, based on data indicating the generation date/time (capturing date/time) and generation location of the image, into the same event as other still images generated, for example, in a predetermined period (for example, one day) and attaches identification information of the event (event ID) to each classification.

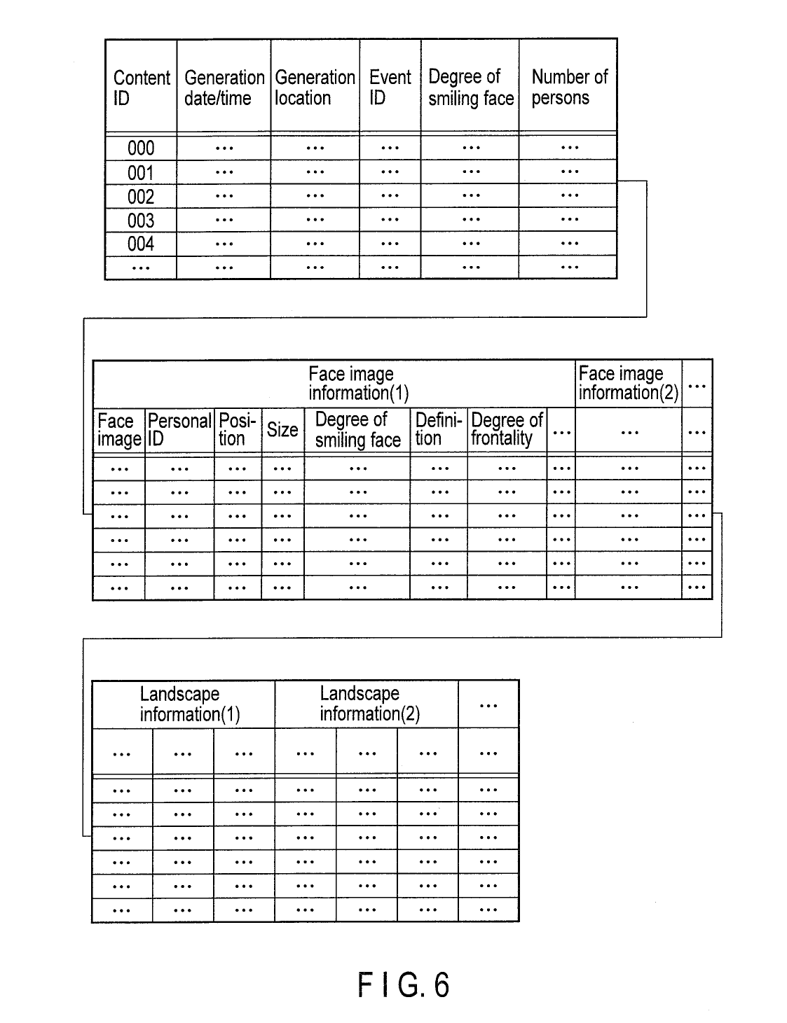

FIG. 6 is a diagram showing an example of analysis information recorded in the content data table 52A according to the first embodiment.

As shown in FIG. 6, analysis information contains a plurality of entries corresponding to a plurality of respective pieces of content. Each entry contains, for example, the content ID, generation date/time (capturing date/time), generation location (capturing location), event ID, degree of smiling face, number of persons, and face image information. The degree of smiling face shows information decided by totalizing degrees of smiling faces of face images contained in the image. The number of persons shows the total of the number of face images contained in the image.

The face image information is recognition result information of face images contained in the image. The face image information contains, for example, the personal ID, position, size, degree of smiling face, definition, and degree of frontality. When a plurality of face images is contained in an image, face image information corresponding to each of a plurality of face images (face image information (1), (2), . . . ) is contained.

The landscape information is recognition result information of landscape images contained in the image. The landscape information shows, for example, the type of a landscape (landscape ID) and information showing objects (natural objects, structures and the like) contained in the landscape. When a plurality of types of landscape images is contained in an image, landscape image information corresponding to each of a plurality of landscape images (landscape information (1), (2), . . . ) is contained.

When an object is detected from content (step A3, Yes), the object data processing module 50D records the object ID, detection source content ID, object group ID, and object priority in the object data table 52B of the content analysis database 52 in accordance with an analysis result by the object analysis module 50B (step A4).

When the object is a face image of a person, the object ID is the ID of the detected face image and the object group ID is the personal ID indicating to which person the face belongs. The object priority is a value calculated from, for example, the definition and the degree of smiling face of the face image. For example, the object priority may be an added value of the definition and the degree of smiling face, a calculated value by assigning weights to the definition or the degree of smiling face, or a calculated value by including the degree of frontality.

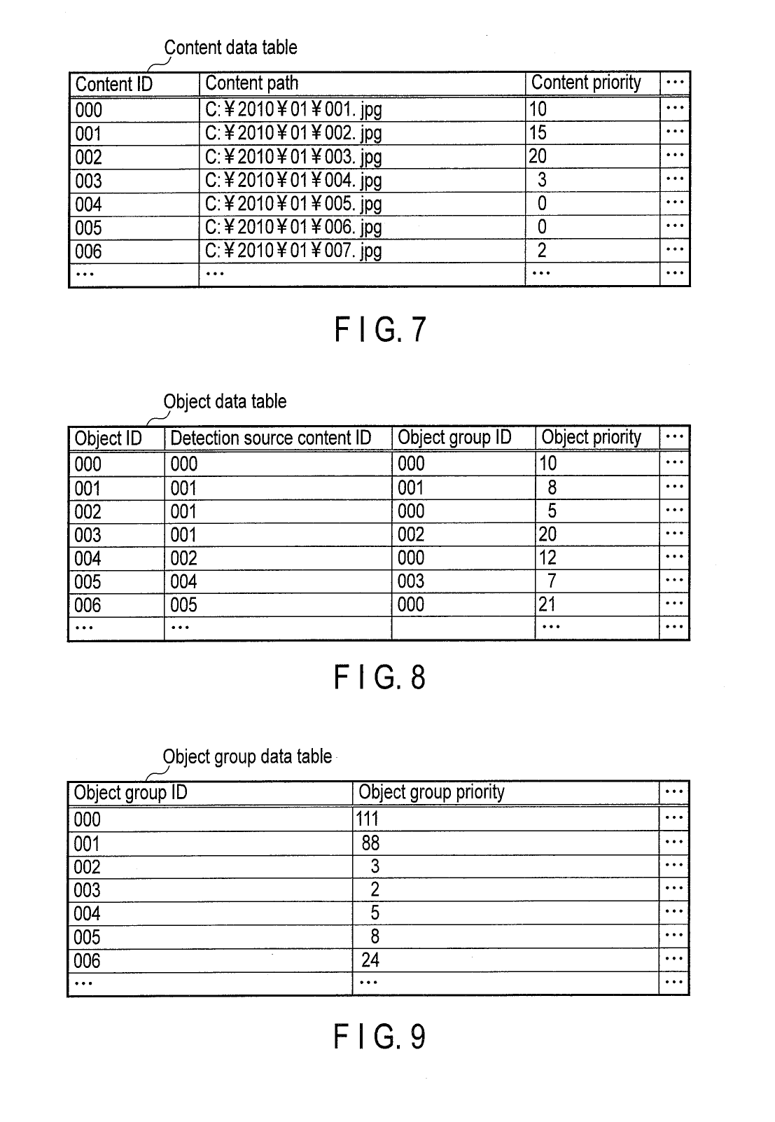

Next, like the content data table 52A shown in FIG. 7, the content data processing module 50C records the content path showing the storage location of content by associating with the content ID (step A5).

By calculating the object priority based on attributes contained in analysis information such as the definition, degree of smiling face, and degree of frontality of a face image (object) in this manner, a representative image that can easily be recognized by the user is more likely to be adopted.

When the analysis of content recorded in the content storage module 54 is completed, the object data processing module 50D records, as shown in FIG. 9, the object group ID and object group priority in the object group data table 52C (step A6).

The object group priority is calculated from the state of appearance of an object belonging to the object group ID based on, for example, data recorded in the object data table 52B. For example, the number of pieces of content including each object of the object group is determined as the state of appearance.

In the case of the object data table 52B shown in FIG. 8, objects contained in the object group ID “000” are shown by the object IDs “000”, “002”, “004”, “006”, . . . . Thus, content containing the object IDs “000”, “002”, “004”, “006”, . . . is shown by the detection source content IDs “000”, “001”, “002”, and “005”. Accordingly, the number of pieces of content including each object of the object group can be determined.

When the total of reproduction time of content containing objects or the total of time appearing in content of objects is set as the state of appearance, the time in which objects appear is calculated for dynamic images and the accumulated value is calculated after converting an image file containing objects into a time determined in advance for still images.

When the total of area appearing in content of objects is set as the state of appearance, a region corresponding to objects is detected for still images and a region corresponding to objects in a first (or last or intermediate) image in which objects appear is detected for dynamic images and then the area thereof is totaled.

Next, the content data processing module 50C calculates the content priority for each piece of content (content ID) based on the object data table 52B and the object group data table 52C and records the content priority in the content data table 52A by associating with the content ID (step A7). The priority of content is a value calculated based on object priorities of objects contained in the content and the priority of the object group. For example, the product of the object priority of an object contained in content and the object group priority of the object group in which the object is contained is calculated for each piece of content and the value of the product determined for each object is totaled.

Regarding content of the content ID “000”, for example, the product of the object priority “10” of the object ID “000” corresponding to the detection content “000” and the object group priority “111” of the object group ID “000” corresponding to the object ID “000” is calculated.

Regarding content of the content ID “001”, the object IDs “001”, “002”, “003” are contained and thus, the product of the object priority corresponding to each of the object IDs “001”, “002”, “003” and the respective object group priority is determined and the product corresponding to each object ID is totalized. The content data processing module 50C decides the content priority based on the value calculated as described above and records, as shown in FIG. 7, the content priority by associating with each content ID.

Because the content priority is calculated based on analysis results of content recorded in the content storage module 54 as described above, the content priority may be changed when content recorded in the content storage module 54 is added or deleted.

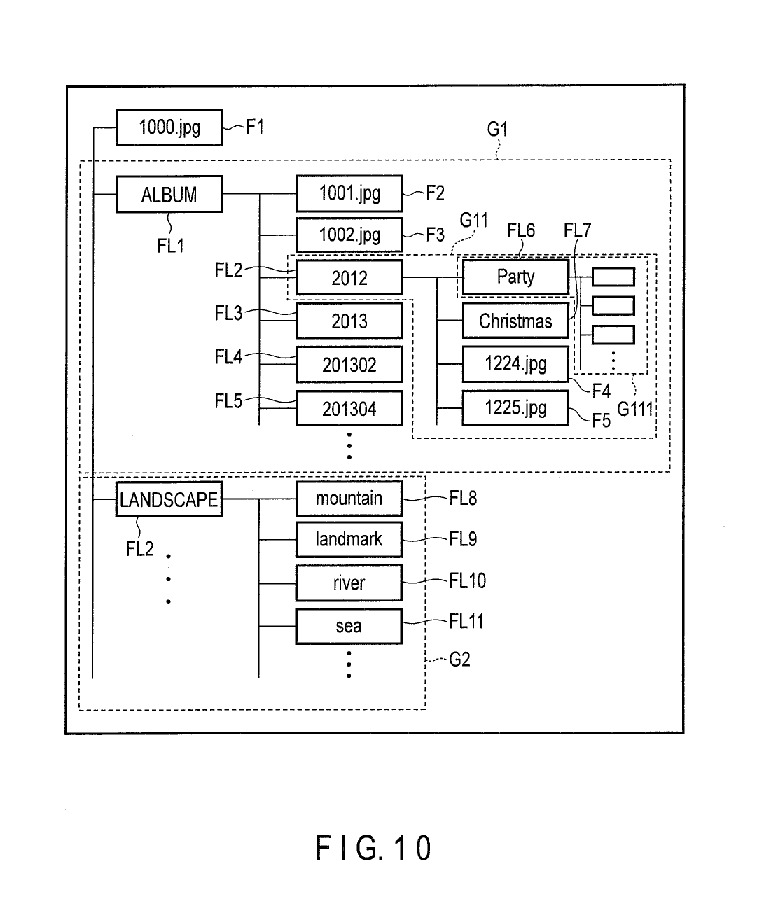

FIG. 10 is a diagram showing an example of a logical hierarchical structure constructed in the content storage module 54.

In FIG. 10, a file F1 and a plurality of folders, a folder FL1 (folder name “ALBUM”) and a folder FL2 (folder name “LANDSCAPE”), are provided in the top layer. In addition to image files F2, F3, a plurality of folders FL2, FL3, FL4, FL5 is created in the folder FL1. Further, data files or folders are contained in each of the folders FL2, FL3, FL4, FL5. In FIG. 10, in addition to folders FL6, FL7 provided in a lower layer, image files F4, F5 are shown in the folder FL2.

For example, in a case of deciding the representative image of the folder FL1, the content server 15 in the present embodiment calculates the content priority based on results of analyzing all content (data files) contained in the folder FL1. Thereby, the content server 15 decides the content of the highest content priority as the representative image of the folder FL1. That is, in FIG. 10, the representative image is decided for the folder FL1 based on all content (data files) contained in a group G1. Similarly, the representative image is decided for the folder FL2 based on all content (data files) contained in a group G2.

For the sub-folder FL2 of the folder FL1, the representative image is decided based on all content (data files) of lower layers of the sub-folder FL2 contained in a group G11. Further, for the sub-folder FL6 of the folder FL2, the representative image is decided based on all content (data files) of lower layers of the folder FL6 contained in a group G111.

Incidentally, the representative image may not content (image file) itself and may be a partial image containing objects. In addition, not only the content of the highest content priority can be decided as the representative image, but also a plurality of pieces of content can be decided as representative images in descending order of content priority. For the plurality of pieces of content of high content priority, for example, the number of pieces of content may be a predetermined number (for example, four) or content whose content priority is higher than a predetermined reference value may be selected.

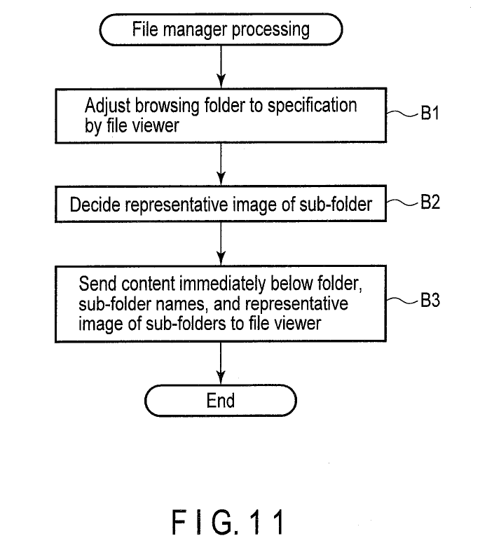

Next, a case when a data file recorded on the content server 15 from the electronic device 10 is browsed will be described. FIG. 11 is a flow chart showing the operation of the file manager 56 of the electronic device 10.

To browse content recorded on the content server 15, the user accesses the content server 15 by using the electronic device 10. The user specifies the folder to be browsed (browsing folder) through the file viewer 60 by operating the user interface 62.

When the specification of the browsing folder is received from the file viewer 60, the file manager 56 of the content server 15 adjusts the browsing folder to the specification of the file viewer 60 (step B1).

Next, the file manager 56 refers to the content data table 52A to decide content of high content priority from among contents contained in sub-folders of the browsing folder as the representative image of the sub-folders (step B2).

The file manager 56 transmits content immediately below the browsing folder, sub-folder names, and the representative image of the sub-folders to the file viewer 60 (step B3).

Based on the content, sub-folder names, and the representative image of the sub-folders transmitted from the file manager 56, the file viewer 60 generates a folder browsing screen and outputs the screen to the display 41A through the display processing module 64. When displaying a sub-folder, the file viewer 60 adds a representative image to an icon representing the folder to display the sub-folder.

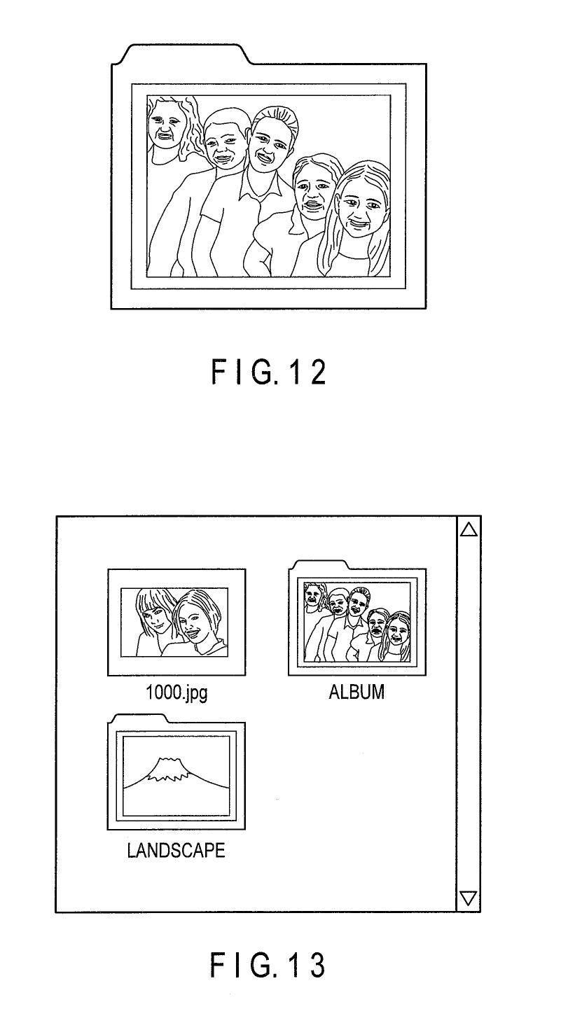

FIG. 12 is a diagram showing an example in which a representative image is added to an icon of a folder. As shown in FIG. 12, the representative image as a thumbnail is displayed in the center of an icon representing the folder.

FIG. 13 is a diagram showing an example of the folder browsing screen in the first embodiment. The folder browsing screen shown in FIG. 13 shows an example when the top layer shown in FIG. 10 is specified as the browsing folder.

As shown in FIG. 13, the file F1 (image file “1000.jpg”) is displayed as a thumbnail and also respective representative images are added to two sub-folders (folder names “ALBUM”, “LANDSCAPE”).

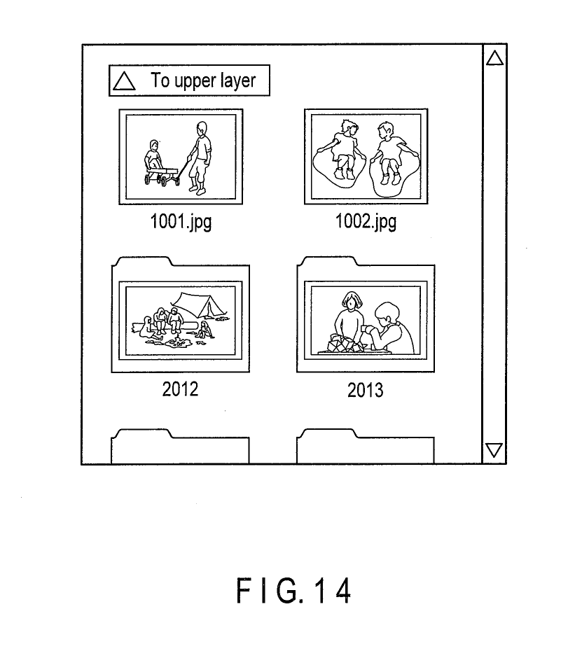

Further, if the folder of the folder name “ALBUM” shown in FIG. 13 is specified as the browsing folder, the file viewer 60 receives the content immediately below the browsing folder, sub-folder names, and the representative image of the sub-folders from the file manager 56 to cause the display to display, as shown in FIG. 14, the folder browsing screen.

As shown in FIG. 14, each folder icon representing a sub-folder has the representative image decided based on content contained in each folder added thereto. Therefore, the user can estimate content contained in sub-folders based on the representative image without the need to open a sub-folders and check files or sub-folders contained in the sub-folder.

### Second Embodiment

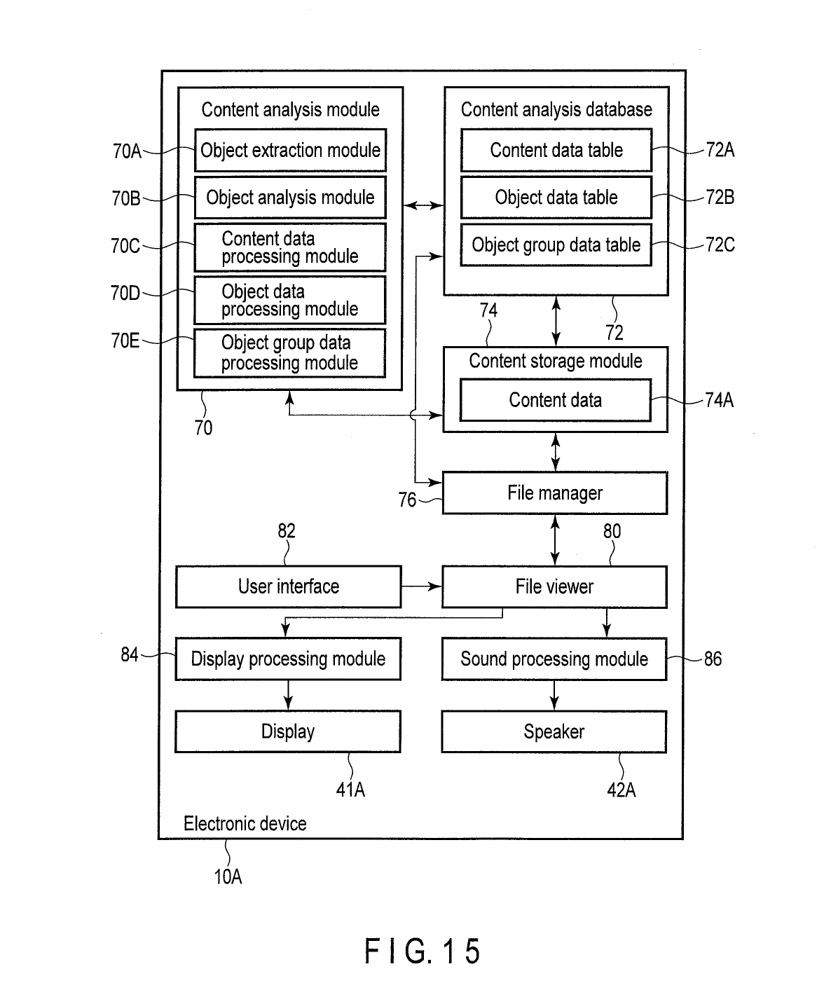

FIG. 15 is a block diagram showing the function configuration of an electronic device 10A according to the second embodiment. The representative image is decided by the content server 15 in the first embodiment, but in the second embodiment, content is recorded in the electronic device 10A and the representative image is decided based on the content.

The electronic device 10A is realized by the system configuration shown in FIG. 3. Incidentally, the electronic device 10A is not limited to the personal computer and can also be realized by other devices such as a table PC, mobile phone, smartphone, and audio player.

The electronic device 10A in the second embodiment includes a content analysis program 34C to realize a content analysis module 70 and a file manager program 34D to realize a file manager 76. A content storage module 54 is realized by, for example, an SSD 38.

In the configuration shown in FIG. 15, elements to which the same names as those in FIG. 4 are attached are assumed in the same manner as in the first embodiment and a detailed description thereof is omitted.

As shown in FIG. 15, even the electronic device 10A operating on a standalone basis can calculate the content priority based on analysis results of content recorded in a content storage module 74 and cause a display to display a folder browsing screen on which the representative image is attached to a folder based on the content priority.

Thus, the user can estimate content recorded in a folder based on the representative image without the need to open the folder displayed on the folder browsing screen.

In the description in the first and second embodiments, examples in which the representative image is added when a folder icon on the folder browsing screen is displayed are described, but when an object other than the folder representing a logical recording location of a folder is displayed, the representative image can be added to the object representing the recording location and displayed.

Processing described in the above embodiments can be provided as a program a computer can be caused to execute to various apparatuses by writing the program into a recording medium, for example, a magnetic disk (flexible disk, hard disk and the like), optical disk (CD-ROM, DVD and the like), or a semiconductor memory. Alternatively, the program can be provided to various apparatuses through transmission by a communication medium. The computer reads the program recorded in the recording medium or receives the program via the communication medium and performs the above processing by an operation thereof being controlled by the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a recording module configured to record a plurality of image files at logical recording locations;
an analysis module configured to analyze attributes of the plurality of image files;
a decision module configured to decide a representative image for each of the recording locations based on the attributes; and
a sending module configured to send the representative image.

2. The electronic device of claim 1, wherein the decision module is configured to decide the representative image based on a representative object extracted from the image file based on the attributes of the plurality of image files.

3. The electronic device of claim 2, wherein the decision module is configured to calculate a first priority for each of a plurality of objects contained in the plurality of image files based on the attributes and extract the representative object based on the first priority.

4. The electronic device of claim 2, wherein the decision module is configured to discriminate a state of appearance for each of a plurality of objects contained in the plurality of image files, calculate a second priority of the plurality of objects based on the state of appearance, and extract the representative object based on the second priority.

5. The electronic device of claim 1, further comprising: a display module configured to display after adding the representative image to an object representing the logical recording location.

6. A method comprising:
recording a plurality of image files at logical recording locations;
analyzing attributes of the plurality of image files;
deciding a representative image for each of the recording locations based on the attributes; and
sending the representative image.

7. The method of claim 6, wherein the deciding the representative image comprises deciding the representative image based on a representative object extracted from the image file based on the attributes of the plurality of image files.

8. The method of claim 7, further comprising: calculating a first priority for each of a plurality of objects contained in the plurality of image files based on the attributes and extracting the representative object based on the first priority.

9. The method of claim 7, further comprising: discriminating a state of appearance for each of a plurality of objects contained in the plurality of image files, calculating a second priority of the plurality of objects based on the state of appearance, and extracting the representative object based on the second priority.

10. The method of claim 6, further comprising: displaying after adding the representative image to an object representing the logical recording location.

11. A non-transitory computer-readable storage medium having stored thereon a computer program which is executable by a computer, the computer program causing a computer to function as:
a recording module configured to record after classifying a plurality of image files at logical recording locations;
an analysis module configured to analyze attributes of the plurality of image files;
a decision module configured to decide a representative image for each of the recording locations based on the attributes; and
a sending module configured to send the representative image.

12. The computer-readable storage medium of claim 11, wherein the decision module is configured to decide the representative image based on a representative object extracted from the image file based on the attributes of the plurality of image files.

13. The computer-readable storage medium of claim 12, wherein the decision module is configured to calculate a first priority for each of a plurality of objects contained in the plurality of image files based on the attributes and extract the representative object based on the first priority.

14. The computer-readable storage medium of claim 12, wherein the decision module is configured to discriminate a state of appearance for each of a plurality of objects contained in the plurality of image files, calculate a second priority of the plurality of objects based on the state of appearance, and extract the representative object based on the second priority.

15. The computer-readable storage medium of claim 11 causing the computer to further function as:
a display module configured to display after adding the representative image to an object representing the logical recording location.
